(19) United States
(12) Patent Application Publication
(10) Pub. No.: US 2025/0109239 A1
(43) Pub. Date: Apr. 3, 2025

(54) Soft Polyurethane Foams Based on Aliphatic Oligomeric Polyisocyanates, and Monohydroxy-Functional Compounds

(71) Applicant: Covestro Deutschland AG, Leverkusen (DE)

(72) Inventors: Lutz Boehnke, Overath (DE); Sven Meyer-Ahrens, Leverkusen (DE); Veronika Eilermann, Sandefjord (NO)

(21) Appl. No.: 18/833,540

(22) PCT Filed: Jan. 23, 2023
(86) PCT No.: PCT/EP2023/051470

§ 371 Date: Jul. 26, 2024

(30) Foreign Application Priority Data
Jan. 28, 2022 (EP) 22153910.9

(51) Int. Cl. C08G 18/66; C08G 18/28; C08G 18/32; C08G 18/48; C08G 18/73; C08G 18/79

(52) U.S. Cl. CPC C08G 18/6688; C08G 18/282; C08G 18/3206; C08G 18/3275; C08G 18/4829; C08G 18/73; C08G 18/792; C08G 2110/0008; C08G 2110/0083

(57) ABSTRACT

The present invention relates to a method for producing soft polyurethane foams, which have in particular a low compression hardness and/or a low compression set value (DVR), using aliphatic oligomeric polyisocyanates and monohydroxy-functional compounds, and the use of aliphatic oligomeric polyisocyanates in combination with monohydroxy-functional compounds in order to reduce the compression hardness and/or the compression set value (DVR) of soft polyurethane foams. The invention also relates to a soft polyurethane foam, that is preferably flexible, which is produced or can be produced by the aforementioned method and has a low compression hardness and/or a low compression set value (DVR), as well as to the use thereof, for example, for the production of body-supporting elements such as upholstery, mattresses, furniture, automobile seats, and motorbike seats.

### CROSS-REFERENCE TO RELATED APPLICATIONS

This application is the United States national phase of International Patent Application No. PCT/EP2023/051470 filed Jan. 23, 2023, and claims priority to European Patent Application No. 22153910.9 filed Jan. 28, 2022, the disclosures of which are hereby incorporated by reference in their entireties.

### BACKGROUND

### Technical Field

The present invention relates to a process for producing flexible polyurethane foams which especially have a low compressive strength and/or a low compression set value (CS) using aliphatic oligomeric polyisocyanates and monohydroxy-functional compounds and to the use of aliphatic oligomeric polyisocyanates in conjunction with monohydroxy-functional compounds for reducing the compressive strength and/or the compression set value (CS) of flexible polyurethane foams. The invention further relates to a preferably flexible polyurethane foam which is produced or producible by the abovementioned process and has a low compressive strength and/or a low compression set value (CS) and to the use thereof, for example for producing body-supporting elements such as upholstery, mattresses, furniture, automobile seats and motorcycle seats.

### Description of Related Art

Flexible foams account for the greatest volume for the use of polyurethanes and are the largest category of polymeric cellular materials. They are mainly used for upholstery in the furniture industry, for mattresses, in the automotive industry and in the textile industry. Presently commercially available flexible foams are typically produced from petroleum-based polyols and aromatic isocyanates, usually from a mixture of toluene 2,4-diisocyanate (2,4-TDI) and toluene 2,6-diisocyanate (2,6-TDI) or diphenylmethane diisocyanate mixtures (MDI).

Conventional polyurethane foams based on these aromatic isocyanates are not color-stable and discolor after a time, while polyurethane foams based on aliphatic isocyanates are color- and light-stable. Production of the latter foams typically employs cycloaliphatic isocyanates such as isophorone diisocyanate (IPDI) or bis(4-isocyanatocyclohexyl) methane (H12MDI) (DE 2447067 A1). Linear aliphatic diisocyanates are normally not used or not used as the sole isocyanate component since such foams have relatively poor mechanical properties. Thus, US 2006/0160977 A1 describes the use of a mixture of hexamethylene diisocyanate (HDI) with either IPDI or H12MDI for the production of foams.

A disadvantage of many of the existing polyurethane foam formulations—and thus also of the formulations described in the above-cited documents—is that these are based almost exclusively on monomeric diisocyanate units. The use of monomeric diisocyanates for producing polyurethane foams makes great demands on process safety and air handling with respect to volatile constituents. The use of low-monomer oligomeric polyisocyanates instead of the volatile monomeric isocyanates represents a major advantage in terms of occupational health and safety.

Light-resistant foams based on aliphatic isocyanates/polyisocyanates with an oligomeric structure are described in EP0006150 B1, EP 3296336 A1 and WO 02/074826 A1 for example. Thus EP0006150 B1 discloses the use of HDI-based biurets or of urethane-modified polyisocyanates from aliphatic/cycloaliphatic diisocyanates and low molecular weight alkanediols. EP 3296336 A1 discloses the use of pentamethylenediisocyanate-based (PDI) uretdiones for production of polyurethanes, wherein isocyanurate and allophanates based on PDI or HDI may likewise be present. Finally, WO 02/074826 A1 discloses the use of isocyanurates or biurets based on aliphatic isocyanates, such as HDI. Reaction of these polyisocyanates with long-chain polyether polyols/polyester polyols and crosslinkers and also blowing agents and foam stabilizers makes it possible to obtain polyurethane foams.

It is an object of the present invention to provide flexible polyurethane foams based on aliphatic oligomeric polyisocyanates suitable for use in typical flexible foam applications such as upholstery, mattresses, furniture, automobile seats and motorcycle seats. In particular the foams should exhibit mechanical properties which are improved relative to foams of the prior art, especially in terms of compressive strength and compression set value (CS). This applies especially to high-quality soft, flexible polyurethane foams based on aliphatic oligomeric polyisocyanates. The production of these flexible foams should also be able to employ reactants based on CO₂ and/or based on renewable raw materials in order to improve the environmental and CO₂ footprint of these flexible polyurethane foams.

### SUMMARY

These objects were achieved by a process for producing flexible polyurethane foams by reaction of a composition comprising the components
A) at least one monohydroxy-functional compound and at least one polyol and
B) at least one aliphatic oligomeric polyisocyanate
   at an isocyanate index of at least 80, in particular of 85 to 115, preferably of 90 to 110, wherein the composition further contains the components C) to F)
C) at least one chemical and/or physical blowing agent;
D) at least one catalyst;
E) optionally a surface-active compound and
F) optionally auxiliary and additive substances distinct from component E).

The term “composition comprising the components” is to be understood as meaning that the composition contains or consists of the components A to F. In a preferred embodiment the composition consists of the components A to F.

The invention further relates to a flexible polyurethane foam obtained or obtainable by the process according to the invention.

The invention also relates to the use of the flexible polyurethane foams according to the invention as or for production of body-supporting elements, in particular upholstery, mattresses, furniture, automobile seats and motorcycle seats.

The invention additionally relates to the use of a monohydroxy-functional compound in conjunction with an aliphatic oligomeric polyisocyanate at an isocyanate index of at least 80, in particular of 85 to 115, preferably of 90 to 110, for reducing the compressive strength and/or the compression set value of flexible polyurethane foams.

### DETAILED DESCRIPTION

It has surprisingly been found that aliphatic oligomeric polyisocyanates, in particular those of the isocyanurate or iminooxadiazinedione type, in conjunction with monohydroxy-functional compounds result in flexible polyurethane foams which meet the recited requirements and which especially exhibit an improved compressive strength (4th cycle, measured according to DIN EN ISO 3386-1) preferably of ≤14.0 kPa, particularly preferably of ≤8 kPa, and an improved CS value (measured according to DIN EN ISO 1856-2008) preferably of ≤3.5%.

A flexible polyurethane foam is typically understood as meaning a foam used in the field of upholstery, mattresses, packaging, automobile applications and footwear. From a chemical standpoint flexible polyurethane foams are polyaddition products of polyols and typically diisocyanates which are produced in an exothermic reaction via the usually chemically produced blowing agent CO₂ formed from the NCO-water reaction. The gelling reaction (NCO—OH reaction) and the blowing reaction (NCO-water reaction) may be modified with the use of catalysts, stabilizers and other auxiliaries to form a broad palette of different foams. To a large proportion the employed polyols are preferably long-chain polyols having a functionality of 2 to 3.

### Component A):

The composition according to the invention contains at least one monohydroxy-functional compound and at least one polyol.

### Component A1):

Component A1) employed is selected from primary, secondary and/or tertiary monohydroxy-functional compounds having 1 to 12 carbon atoms, preferably primary monohydroxy-functional compounds. The carbon chains may be saturated or unsaturated, linear or branched, aliphatic or cycloaliphatic or aromatic and may contain heteroatoms such as oxygen.

Preferably concerned here are low molecular weight monohydroxy-functional compounds (alcohols) having a molecular weight of 32.04 g/mol to 186.34 g/mol which, aside from the hydroxy functionality (OH group), preferably comprise no further functionalities (for example ether or ester functionalities etc). Preference is especially given to acyclic and/or cyclic monohydroxy-functional alkanols and/or acyclic and/or cyclic monohydroxy-functional alkenols. Examples include methanol, ethanol, isopropanol, n-propanol, isobutanol, n-butanol, sec-butanol, tert-butanol, pentan-1-ol, pentan-2-ol, pentan-3-ol, 2-methylbutan-1-ol, 2-methylbutan-2-ol, 3-methylbutan-1-ol, 3-methylbutan-2-ol, 2,2-dimethylpropan-1-ol, hexan-1-ol, hexan-2-ol, hexan-3-ol, 2-methylpentan-1-ol, 3-methylpentan-1-ol, 4-methylpentan-1-ol, 2-methylpentan-2-ol, 3-methylpentan-2-ol, 2,2-dimethylbutan-1-ol, 2,3-dimethylbutan-1-ol, 3,3-dimethylbutan-1-ol, 2,3-dimethylbutan-2-ol, 3,3-dimethylbutan-2-ol, 2-ethyl-1-butanol, 2-methyl-3-butyn-2-ol, 3-butyn-1-ol, propargyl alcohol, 1-tert-butoxy-2-propanol, 1-heptanol, 2-heptanol, 3-heptanol, 4-heptanol, 1-octanol, 2-octanol, 3-octanol, 4-octanol, 1-nonanol, 2-nonanol, 3-nonanol, 4-nonanol, 5-nonanol, 1-decanol, 2-decanol, 3-decanol, 4-decanol, 5-decanol, 1-undecanol, 2-undecanol, 3-undecanol, 4-undecanol, 5-undecanol, 6-undecanol, 1-dodecanol, 2-dodecanol, 3-dodecanol, 4-dodecanol, 5-dodecanol, 6-dodecanol or mixtures thereof. Preference is also given to monohydroxyl-functional compounds having a melting point of ≤60° C., very particularly preferably of ≤40° C. and most preferably ≤20° C. Especially preferred are low molecular weight primary monohydroxy-functional compounds since the markedly higher reactivity thereof ensures faster reaction with the isocyanate groups.

### Component A2):

Components A2) employed include polymeric monohydroxy-functional compounds, preferably polyether monools, polycarbonate monools, polyester carbonate monools, polyether carbonate monools, polyether ester carbonate monools and/or mixtures thereof, wherein the polymeric monohydroxy-functional compound particularly preferably has a primary hydroxyl group. The polymeric monohydroxy-functional compound A2) preferably has a hydroxyl number of 20 to 250 mg KOH/g, preferably 20 to 112 mg KOH/g and particularly preferably 20 to 50 mg KOH/g, measured according to DIN 53240-3:2016-03.

The production of these compounds may be carried out by catalytic addition of one or more alkylene oxides onto H-functional starter compounds. Employable alkylene oxides (epoxides) include alkylene oxides having 2 to 24 carbon atoms. The alkylene oxides having 2 to 24 carbon atoms are, for example, one or more compounds selected from the group comprising or consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyloxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides employed are preferably ethylene oxide and/or propylene oxide and/or 1,2-butylene oxide. The alkylene oxides may be introduced into the reaction mixture individually, in admixture or successively. The copolymers may be random or block copolymers. Adding the alkylene oxides successively has the result that the products (polyether polyols) produced contain polyether chains having block structures.

In a preferred embodiment of the invention the proportion of ethylene oxide in the altogether employed amount of propylene oxide and ethylene oxide is ≥0% and ≤90% by weight, preferably ≥0% and ≤60% by weight. Particular preference is given to polyether polyols having terminal primary hydroxyl groups since these have a greater reactivity towards isocyanates.

The H-functional starter compounds are monofunctional for the production of polyether monools. In the context of the present invention “H-functional” is to be understood as meaning a starter compound having alkoxylation-active H atoms. Compounds employable therefor include alcohols, amines, thiols and carboxylic acids. Examples of preferred monofunctional alcohols include methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine or 4-hydroxypyridine. Suitable monofunctional amines include: butylamine, tert-butylamine, pentylamine, hexylamine, aniline, aziridine, pyrrolidine, piperidine, morpholine. Employable monofunctional thiols include: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid. Particularly suitable starter compounds include compounds from the group of glycol ethers, for example diethylene glycol monoethyl ether. The monofunctional starter compounds are preferably diethylene glycol monobutyl ether (butyl diglycol).

It is further preferable when the amount of substance fraction of OH groups in the sum of components A1) and A2) is 25.0 mol % to 90.0 mol %, more preferably 35.0 to 85.0 mol %, particularly preferably 40.0 to 80.0 mol %, based on the total amount of substance of OH groups in component A).

The equivalent ratio of OH groups in the sum of components A1) and A2) to the NCO groups of components B) is preferably 0.15 to 0.65, more preferably 0.20 to 0.55 and particularly preferably 0.25 to 0.50.

### Component A3):

The polyether carbonate polyols employable as component A3) have a hydroxyl number (OH number) according to DIN 53240-3:2016-03 of ≥20 mg KOH/g to ≤600 mg KOH/g, preferably of ≥50 mg KOH/g to ≤500 mg KOH/g, particularly preferably of ≥50 mg KOH/g to ≤300 mg KOH/g.

Production of the polyether carbonate polyols may employ the same alkylene oxides (epoxides) and the same H-functional starter substances as also described below for production of the polyether polyols (see component A4).

The copolymerization of carbon dioxide and one or more alkylene oxides is preferably effected in the presence of at least one DMC catalyst (double metal cyanide catalyst).

For example the production of polyether carbonate polyols comprises the steps of:
(α) initially charging an H-functional starter substance or a mixture of at least two H-functional starter substances and removing any water and/or other volatile compounds through elevated temperature and/or reduced pressure (“drying”), wherein the DMC catalyst is added to the H-functional starter substance or to the mixture of at least two H-functional starter substances before or after drying,
(β) adding a sub-amount (based on the total amount of the amount of alkylene oxides employed in the activation and copolymerization) of one or more alkylene oxides to the mixture resulting from step (α) for activation, wherein this addition of a sub-amount of alkylene oxide may optionally be carried out in the presence of CO₂ and wherein the temperature spike (“hotspot”) which then occurs due to the exothermic chemical reaction that follows and/or a pressure drop in the reactor is awaited in each case, and wherein step (β) for activation may also be carried out two or more times,
(γ) adding one or more of the alkylene oxides and carbon dioxide to the mixture resulting from step (β), wherein the alkylene oxides used in step (γ) may be identical or different to the alkylene oxides used in step (β) and wherein no further alkoxylation step follows after step (γ).

DMC catalysts are known in principle from the prior art for homopolymerization of epoxides (see, for example, U.S. Pat. Nos. 3,404,109, 3,829,505, 3,941,849, and 5,158,922). DMC catalysts, described for example in U.S. Pat. No. 5,470,813, EP-A 700 949, EP-A 743 093, EP-A 761 708, WO-A 97/40086, WO-A 98/16310 and WO-A 00/47649, have a very high activity in the homopolymerization of epoxides and allow production of polyether polyols and/or polyether carbonate polyols at very low catalyst concentrations (25 ppm or less). A typical example is the highly active DMC catalysts described in EP-A 700 949, which comprise not only a double metal cyanide compound (for example zinc hexacyanocobaltate (III)) and an organic complex ligand (for example tert-butanol) but also a polyether having a number-average molecular weight Mn of greater than 500 g/mol.

The DMC catalyst is usually employed in an amount of ≤1% by weight, preferably in an amount of ≤0.5% by weight, particularly preferably in an amount of ≤500 ppm and in particular in an amount of ≤300 ppm, in each case based on the weight of the polyether carbonate polyol.

In a preferred embodiment of the invention the polyether carbonate polyol of component A3) has a content of carbonate groups (“units originating from carbon dioxide”), calculated as CO₂, of ≥2.0% and ≤30.0% by weight, preferably of ≥5.0% and ≤28.0% by weight and particularly preferably of ≥10.0% and ≤25.0% % by weight.

The polyether carbonate polyols to be used according to the invention preferably also comprise ether groups between the carbonate groups as shown schematically in formula (I). In the scheme according to formula (I), R′ represents an organic radical such as for example alkyl, alkylaryl or aryl, each of which may also comprise heteroatoms such as for example O, S, Si, etc. The indices e and f represent an integer. The polyether carbonate polyol shown in the scheme according to formula (I) should be understood as meaning merely that blocks having the structure shown may in principle be present in the polyether carbonate polyol, but the sequence, number and length of the blocks may vary and is not restricted to the polyether carbonate polyol shown in formula (I). Having regard to formula (I) this is to be understood as meaning that the ratio of e/f is preferably from 2:1 to 1:20, more preferably from 1.5:1 to 1:10.

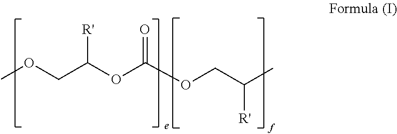

The proportion of incorporated CO₂ (“units originating from carbon dioxide”) in a polyether carbonate polyol may be determined from the evaluation of characteristic signals in the 1H NMR spectrum. The example which follows illustrates determination of the proportion of units originating from carbon dioxide in a 1,8-octanediol-started CO₂/propylene oxide polyether carbonate polyol.

The proportion of incorporated CO₂ in a polyether carbonate polyol and the ratio of propylene carbonate to polyether carbonate polyol may be determined by ¹H NMR (a suitable instrument is the DPX 400 instrument from Bruker, 400 MHz; pulse program zg30, delay time d1:10 s, 64 scans). Each sample is dissolved in deuterated chloroform. The relevant resonances in the 1H NMR (based on TMS=0 ppm) are as follows:

Cyclic carbonate (which was formed as a by-product) having a resonance at 4.5 ppm; carbonate resulting from carbon dioxide incorporated in the polyether carbonate polyol having resonances at 5.1 to 4.8 ppm; unreacted propylene oxide (PO) having a resonance at 2.4 ppm; polyether polyol (i.e. without incorporated carbon dioxide) having resonances at 1.2 to 1.0 ppm; the octane-1,8-diol incorporated as starter molecule (if present) having a resonance at 1.6 to 1.52 ppm.

The weight fraction (in % by weight) of polymer-bound carbonate (LC′) in the reaction mixture was calculated by formula (II)

$$LC ' = \frac{[ C ( 5.1 - 4.8 ) - C ( 4.5 ) ] * 102}{N} * 100 \% \qquad Formula ( II )$$

wherein the value of N (“denominator” N) is calculated according to formula (III):

$$N = ⌊ C ( 5.1 - 4.8 ) - C ( 4.5 ) ⌋ * 102 + C ( 4.5 ) * 102 + C ( 2.4 ) * 58 + 0.33 * C ( 1.2 - 1. ) * 58 + 0.25 * C ( 1.6 - 1.52 ) * 146 \qquad Formula ( III )$$

The following abbreviations are used here:
A (4.5)=area of the resonance at 4.5 ppm for cyclic carbonate (corresponds to one hydrogen atom)
A (5.1-4.8)=area of the resonance at 5.1-4.8 ppm for polyether carbonate polyol and one hydrogen atom for cyclic carbonate
A (2.4)=area of the resonance at 2.4 ppm for free, unreacted propylene oxide
A (1.2-1.0)=area of the resonance at 1.2-1.0 ppm for polyether polyol
A (1.6-1.52)=area of the resonance at 1.6 to 1.52 ppm for octane-1,8-diol (starter), if present.

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The proportion by weight (in % by weight) of cyclic carbonate (CC′) in the reaction mixture was calculated by formula (IV):

$$CC ' = \frac{C ( 4.5 ) * 102}{N} * 100 \% \qquad Formula ( IV )$$

wherein the value of N is calculated according to formula (III).

To calculate the composition based on the polymer proportion (consisting of polyether polyol formed from starter and propylene oxide during the activation steps carried out in the absence of CO₂ and polyether carbonate polyol formed from starter, propylene oxide, and carbon dioxide during the activation steps carried out in the presence of CO₂ and during the copolymerization) from the values for the composition of the reaction mixture, the nonpolymeric constituents of the reaction mixture (i.e. cyclic propylene carbonate and any unreacted propylene oxide present) were mathematically eliminated. The weight fraction of repeating carbonate units in the polyether carbonate polyol was converted to a weight fraction of carbon dioxide by application of the factor F=44/(44+58). The value for the CO₂ content in the polyether carbonate polyol is normalized to the proportion of the polyether carbonate polyol molecule which was formed in the copolymerization and in any activation steps in the presence of CO₂ (i.e. the proportion of the polyether carbonate polyol molecule resulting from the starter (octane-1,8-diol, if present) and from the reaction of the starter with epoxide which was added under CO₂-free conditions was not taken into account here).

To determine the proportion of incorporated CO₂ in a polyether carbonate polyol it is possible to proceed as described previously in respect of the polyether carbonate polyol, with corresponding adjustment of the starter molecule and consequently the above equations.

Polyether carbonate polyols are commercially available from Covestro Deutschland AG under the trade name Cardyon® for example.

It is preferable when the polyol of component A) comprises at least one polyether carbonate polyol A3).

### Component A4):

Polyether polyols, polyester polyols and/or polycarbonate polyols may be employed as component A4). It is preferable when component A4) has an average functionality of >1, particularly preferably of ≥2.

Suitable polyether polyols are those having a hydroxyl number according to DIN 53240-3:2016-03 of ≥20 mg KOH/g to ≤550 mg KOH/g, preferably of >20 to ≤250 mg KOH/g and particularly preferably ≥20 mg KOH/g to ≤80 mg KOH/g. The production of these compounds may be carried out analogously to the production of the polyether monools described above under component A2. Employable alkylene oxides include the alkylene oxides described there and the same preferred ranges also apply. However, production of the polyether polyols employs H-functional starter molecules having an average functionality of >1 to ≤6, preferably of ≥1.5 and ≤6, particularly preferably ≥2 and ≤4, very particularly preferably ≥2 and ≤3.

Suitable H-functional starter substances that may be employed are compounds having alkoxylation-active H atoms. Groups active in respect of the alkoxylation and having active hydrogen atoms are, for example, —OH, —NH₂ (primary amines), —NH— (secondary amines), —SH and —CO₂H, preferably —OH and —NH₂, particularly preferably-OH. Employed H-functional starter substances include for example one or more compounds selected from the group consisting of water, polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines (for example the products called Jeffamines® that are commercially available from Huntsman, for example D-230, D-400, D-2000, T-403, T-3000, T-5000, or corresponding BASF products, for example Polyetheramine D230, D400, D200, T403, T5000), polytetrahydrofurans (for example PolyTHF® from BASF, for example PolyTHF® 250, 650S, 1000, 1000S, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C1-C24-alkyl fatty acid esters containing an average of at least 2 OH groups per molecule. The C1-C24 alkyl fatty acid esters which contain on average at least 2 OH groups per molecule are, for example, commercial products such as Lupranol Balance® (BASF AG), Merginol® products (Hobum Oleochemicals GmbH), Sovermol® products (Cognis Deutschland GmbH & Co. KG), and Soyol®™ products (USSC Co.).

Polyhydric alcohols suitable as H-functional starter substances are, for example, dihydric alcohols (for example ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (for example 3-methyl-1,5-pentanediol), 1,6-hexanediol, 1,8-octanediol, 1,10-decanediol, 1,12-dodecanediol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and all the modification products of these aforementioned alcohols with different amounts of ε-caprolactone. Also employable in mixtures of H-functional starters are trihydric alcohols, for example trimethylolpropane, glycerol, trishydroxyethyl isocyanurate, and castor oil.

The H-functional starter substances may also be selected from the class of the polyether polyols, in particular those having a number-average molecular weight Mn in the range from 100 to 4000 g/mol, preferably 250 to 2000 g/mol. Preference is given to polyether polyols formed from repeating ethylene oxide and propylene oxide units, preferably having a proportion of 35% to 100% propylene oxide units, particularly preferably having a proportion of 50% to 100% propylene oxide units. These may be random copolymers, gradient copolymers, alternating copolymers or block copolymers of ethylene oxide and propylene oxide. Suitable polyether polyols formed from repeating propylene oxide and/or ethylene oxide units are for example the Desmophen®, Acclaim®, Arcol®, Baycoll®, Bayfill®, Bayflex®, Baygal®, PET® and polyether polyols from Covestro Deutschland AG (e.g. Desmophen® 3600Z, Desmophen® 1900U, Acclaim® Polyol 2200, Acclaim® Polyol 4000I, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE.

The H-functional starter substances may also be selected from the class of the polyether polyols, in particular those having a number-average molecular weight Mn in the range from 200 to 4500 g/mol, preferably 400 to 2500 g/mol. At least difunctional polyesters are used as the polyester polyols. Polyester polyols preferably consist of alternating acid and alcohol units. Acid components employed include, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Employed alcohol components include for example ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane diethylene glycol, dipropylene glycol, trimethylolpropane, glycerol, pentaerythritol or mixtures of the alcohols mentioned. Using dihydric or polyhydric polyether polyols as the alcohol component affords polyester ether polyols which may likewise be used as starter substances for producing the polyether carbonate polyols. If polyether polyols are used to produce the polyester ether polyols, preference is given to polyether polyols having a number-average molecular weight Mn of 150 to 2000 g/mol.

The H-functional starter substances employed may additionally be polycarbonate polyols (for example polycarbonate diols), in particular those having a molecular weight Mn in the range from 150 to 4500 g/mol, preferably 500 to 2500, which are produced for example by reaction of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. For example, the polycarbonate diols used may be the Desmophen® C products from Covestro Deutschland AG, for example Desmophen® C 1100 or Desmophen® C 2200.

Polyether carbonate polyols may likewise be used as H-functional starter substances. Polyether carbonate polyols produced by the process described above are used in particular. To this end, these polyether carbonate polyols used as H-functional starter substances are produced in a separate reaction step beforehand.

Preferred H-functional starter substances are alcohols of general formula (V)

HO—(CH2)x-OH Formula (V),

wherein x is a number from 1 to 20, preferably an even number from 2 to 20. Examples of alcohols according to formula (V) are ethylene glycol, 1,4-butanediol, 1,6-hexanediol, 1,8-octanediol, 1,10-decanediol and 1,12-dodecanediol. Further preferred H-functional starter substances are neopentyl glycol, trimethylolpropane, glycerol, pentaerythritol, reaction products of the alcohols of formula (V) with ε-caprolactone, for example reaction products of trimethylolpropane with ε-caprolactone, reaction products of glycerol with ε-caprolactone and reaction products of pentaerythritol with ε-caprolactone. Also preferably employed as H-functional starter substances are water, diethylene glycol, dipropylene glycol, castor oil, sorbitol and polyether polyols formed from repeating polyalkylene oxide units.

The H-functional starter substances are particularly preferably one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, di- and trifunctional polyether polyols, wherein the polyether polyol is formed from a di- or tri-H-functional starter substance and propylene oxide or a di- or tri-H-functional starter substance, propylene oxide and ethylene oxide. The polyether polyols preferably have a number-average molecular weight Mn in the range from 62 to 4500 g/mol and especially a number-average molecular weight Mn in the range from 62 to 3000 g/mol, very particularly preferably a molecular weight of from 62 to 1500 g/mol. The polyether polyols preferably have a functionality of ≥2 to ≤3.

Employable alkylene oxides (epoxides) include alkylene oxides having 2 to 24 carbon atoms. The alkylene oxides having 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyloxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides employed are preferably ethylene oxide and/or propylene oxide and/or 1,2-butylene oxide. The alkylene oxides may be introduced into the reaction mixture individually, in admixture or successively. The copolymers may be random or block copolymers. Adding the alkylene oxides successively has the result that the products (polyether polyols) produced contain polyether chains having block structures.

In a preferred embodiment of the invention the proportion of ethylene oxide in the altogether employed amount of propylene oxide and ethylene oxide is ≥0% and ≤90% by weight, preferably ≥0% and ≤60% by weight. The polyether polyol is preferably “EO capped”, i.e. the polyether polyol has terminal ethylene oxide groups. The primary hydroxyl groups which are then terminal have a greater reactivity towards isocyanates. (G. Oertel, Polyurethane Handbook, 2nd Edition, page 194 and 219, (1993)).

The polyester polyols likewise employable as component A4) are especially those having a number-average molecular weight Mn in the range from 200 to 4500 g/mol, preferably 400 to 3500 g/mol, particularly preferably from 800 to 2500 g/mol. The polyester polyols employed are preferably at least difunctional polyesters. Polyester polyols preferably consist of alternating acid and alcohol units. Acid components employed include, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Employed alcohol components include for example ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane diethylene glycol, dipropylene glycol, trimethylolpropane, glycerol, pentaerythritol or mixtures of the alcohols mentioned. It is also possible to use dihydric or polyhydric polyether polyols as the alcohol component. If polyether polyols are used to produce the polyester ether polyols, preference is given to polyether polyols having a number-average molecular weight Mn of 150 to 2000 g/mol.

Also employable as a further compound class are polycarbonate polyols (for example polycarbonate diols) as component A4), in particular those having a molecular weight Mn in the range from 150 to 4500 g/mol, preferably 500 to 2500, which are produced for example by reaction of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. For example, the polycarbonate diols used may be the Desmophen® C products from Covestro Deutschland AG, for example Desmophen® C 1100 or Desmophen® C 2200.

The described compounds of components A3) and A4) may be used both individually and in mixtures as polyol of component A).

### Component A5):

Compounds employed as component A5) include chain extenders and/or crosslinkers/crosslinking agents. The chain extenders and crosslinkers are preferably NCO-reactive compounds having an OH and/or NH functionality of at least 2 and a molecular weight of 62 to 800 g/mol. These may include for example ethylene glycol, diethylene glycol, 1,2-propanediol, 1,3-propanediol, 1,4-butanediol, 1,6-hexanediol, glycerol, 1,1,1-trimethylolpropane, pentaerythritol, monoethanolamine, diethanolamine and similar low molecular weight compounds and mixtures thereof.

### Component B):

Component B) contains at least one aliphatic oligomeric polyisocyanate. In the context of the present invention aliphatic oligomeric polyisocyanates are to be understood as meaning isocyanate-bearing oligomers which are preferably formed from (2n+1) aliphatic polyisocyanates, wherein n is a natural number from 1 to 10. Accordingly, both symmetrical and asymmetrical trimers, including their higher homologs (such as pentamers, heptamers, etc.), are encompassed by the term “aliphatic oligomeric polyisocyanates”. It is preferable when the aliphatic oligomeric polyisocyanate of component B) consists to an extent of at least 90.0% by weight of these isocyanate-bearing oligomers. The aliphatic oligomeric polyisocyanates preferably contain isocyanurate and/or iminooxadiazindione groups.

Preferably employed as aliphatic oligomeric polyisocyanates of component B) are isocyanate-bearing trimers, wherein component B) especially contains a mixture of this trimer and at least one further isocyanate-bearing oligomer where n is a natural number from 2 to 10. It is preferable when the aliphatic oligomeric polyisocyanate of component B) consists to an extent of at least 30.0% by weight, preferably 30.0% to 80.0% by weight, of these isocyanate-bearing trimers. It is particularly preferable to employ isocyanate-bearing trimers of formula (VI) and/or formula (VII), in each case formed from 3 aliphatic polyisocyanates, wherein R is independently at each occurrence an aliphatic C1 to C15 carbon chain.

### Formula (VI) Formula (VII)

However, the aliphatic oligomeric polyisocyanates are not limited to the abovementioned forms composed of (2n+1) aliphatic polyisocyanates. Thus for example dimers and their higher homologs may also be included in the definition of aliphatic oligomeric polyisocyanates. Accordingly, the aliphatic oligomeric polyisocyanates may also contain uredione, carbodiimide, uretonimine, urethane, allophanate, biuret and urea groups. Hybrid forms, in which two or more of the abovementioned structure types occur in an oligomer, are also included within the definition.

Production of the aliphatic oligomeric polyisocyanates may employ any of the low molecular weight monomeric diisocyanates known to those skilled in the art. For instance, monomeric cyclo- or linear-aliphatic di- and/or polyisocyanates are suitable as starting isocyanates which may be employed individually or in any desired blends. Typical examples include 1,4-diisocyanatobutane, 1,5-diisocyanatopentane (PDI), 1,6-diisocyanatohexane (HDI), 2-methyl-1,5-diisocyanatopentane,

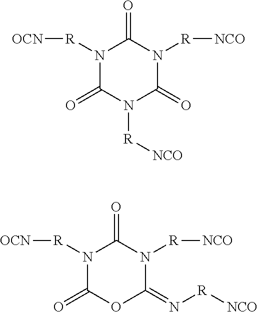

1,5-diisocyanato-2,2-dimethylpentane, 2,2,4- and 2,4,4-trimethyl-1,6-diisocyanatohexane, 1,10-diisocyanatodecane, 1,3-und 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 2,4′- and 4,4′-diisocyanatodicyclohexylmethane, 1-isocyanato-1-methyl-4 (3)-isocyanatomethylcyclohexane (IMCI), bis(isocyanatomethyl) norbornane, triisocyanates and/or higher-functional isocyanates such as for example 4-isocyanatomethyl-1,8-octane diisocyanate (nonane triisocyanate), 1,6,11-undecane triisocyanate, 1,3,5-tris(6-isocyanatopentyl)-1,3,5-triazinane-2,4,6-trione or any desired mixtures of such isocyanate components. The aliphatic oligomeric polyisocyanates are especially produced from a diisocyanate having 1 to 15 carbon atoms. The diisocyanate is preferably selected from 1,5-pentamethylene diisocyanate and/or 1,6-hexamethylene diisocyanate. Suitable commercially available polyisocyanates include inter alia Desmodur® ultra N3300, Desmodur® ultra N3600, Desmodur® N3200, Desmodur® eco N7300 and Desmodur® N3900 (available from Covestro Deutschland AG)

Component B) preferably has an average NCO functionality per molecule of ≥2.0, preferably of 2.3 to 4.3, particularly preferably of 2.5 to 4.2, very particularly preferably of 2.8 to 4.1 and most preferably of 3.0 to 4.0. The NCO functionality refers to free NCO groups and not to latent NCO groups (such as for example the NCO groups forming the ring of the trimers). Unless otherwise stated the average NCO functionality of component B is determined by gel permeation chromatography (GPC). Functionality is a term for the number of reactive groups per molecule, i.e. for the number of potential bonding points in the formation of a network. However, polyisocyanates as formed for example in the trimerization of diisocyanates do not consist only of one defined type of molecule but rather contain a broad distribution of different molecules having different functionalities. The determining parameter reported for the polyisocyanates is therefore the average functionality. The average functionality of polyisocyanates is unambiguously determined by the ratio of number-average molecular weight and equivalent weight and is generally calculated from the molecular weight distribution determined by GPC. Accordingly the average NCO functionality may be calculated after assignment of the individual oligomers in the GPC with the respective functionalities and weighting via their mass fraction. For the polyisocyanates (PIC) bearing only isocyanurate groups and iminooxadiazinedione groups it is also calculable simply via the NCO content of the polyisocyanate according to the following formula:

NCO functionality=(6*PIC NCO content)/[4*PIC NCO content−monomer NCO content)]

For other isocyanate-bearing polyisocyanates (biurets, uretdiones) the NCO functionality must then be determined using the abovementioned calculation. The peaks in the GPC may be assigned to particular structures optionally using further analytical techniques such as NMR, IR and/or MS. Using the NCO functionalities of the determined chemical structures and a weighting via their mass fraction it is then possible to calculate the average NCO functionality of the mixture of polyisocyanates in the GPC. Since oligomerization of di- and polyisocyanates generally does not produce pure products, but rather compounds with different degrees of oligomerization, i.e. oligomer mixtures, the NCO functionality of the resulting compounds can only be reported as an average value and the content of NCO groups can only be reported based on the total weight of the oligomer mixture formed. In the context of the present invention such an oligomer mixture is described simply as an “aliphatic oligomeric polyisocyanate”.

It is further preferable when component B) has a content of free NCO groups of 5.0% to 30.0% by weight, particularly preferably of 10.0% to 27.0% by weight and very particularly preferably of 15.0% to 24.2% by weight based on the total weight of component B) determined according to DIN EN ISO 11909:2007.

In one embodiment of the process according to the invention the isocyanate index is ≥80, preferably from 85 to 115, particularly preferably from 90 to 110. The isocyanate index (also known as the index or NCO/OH index) is to be understood as meaning the quotient of the actually employed amount of substance [mol] of isocyanate groups and the actually employed amount of substance [mol] of isocyanate-reactive groups, multiplied by 100. In other words, the index indicates the percentage ratio of the amount of isocyanate actually used to the stoichiometric amount of isocyanate, i.e. the amount calculated for the conversion of the OH equivalents. An equivalent amount of NCO groups and NCO-reactive hydrogen atoms corresponds to an NCO/OH index of 100.

$$Index = [ ( moles of isocyanate groups ) / ( moles of isocyanate - reactive groups ) ] * 100$$

It is likewise preferable when the composition has a content of monomeric diisocyanates of <1.0% by weight, particularly preferably of <0.5% by weight, very particularly preferably of <0.3% by weight and most preferably of <0.1% by weight based on the total weight of the composition determined by gas chromatography according to DIN EN ISO 10283:2007-11.

### Component C):

Blowing agents are employed as component C. This comprises water and/or physical blowing agents. Physical blowing agents employed include for example carbon dioxide and/or volatile organic substances. These volatile physical blowing agents are cyclic hydrocarbons such as for example cyclopentane and cyclohexane. Non-cyclic hydrocarbons are inter alia butane, n-pentane and isopentane. Also suitable as physical blowing agents are halogen-containing hydrocarbons. These are hydrofluorocarbons or perfluorocarbons, for example perfluoroalkanes. It is preferable to employ water as component C).

### Component D):

Employable components D) include known catalysts such as for example tin catalysts (for example dibutyltin oxide, dibutyltin dilaurate, dimethyltin neodecanoate, dimethyltin(IV) dimercaptide, tin octoate, tin neodecanoate), bismuth 2-ethylhexanoate, cobalt 2-ethylhexanoate, iron 2-ethylhexanoate, iron(III) chloride, aliphatic tertiary amines (for example trimethylamine, tetramethylbutanediamine), cycloaliphatic tertiary amines (for example 1,4-dimethylpiperazine, 1,4-diaza[2.2.2]bicyclooctane, 1,8-diazabicyclo[5.4.0]undec-7-ene, 1,5,7-triazabicyclo[4.4.0]dec-5-ene, N-methyltriazabicyclo[4.4.0]dec-9-ene), 1,1,3,3-tetramethylguanidine, aliphatic amino ethers (for example bis(2-dimethylaminoethyl) ether, N,N,N-trimethyl-N-hydroxyethylbisaminoethyl ether), cycloaliphatic amino ethers (for example N-ethylmorpholine, 4,4′-(oxydi-2,1-ethanediyl)dimorpholine), aliphatic amidines, cycloaliphatic amidines, urea, derivatives of urea (for example aminoalkylureas, see for example EP-A 0 176 013, in particular (3-dimethylaminopropylamino) urea). The catalysts may be added individually or else in a blend with one another. The catalysts can act as gelling and/or blowing catalysts. Many catalysts are not pure gelling or blowing catalysts but may be employed for both purposes. However, one of the two properties may be more pronounced. The compounds tin octoate or tin neodecanoate are regarded as virtually entirely gelling catalysts and bis(2-dimethylaminoethyl ether) as an entirely blowing catalyst. For aliphatic isocyanates 1,8-diazabicyclo[5.4.0]undec-7-ene (DBU) acts predominantly as a blowing catalyst.

In the context of the present invention gelling catalysts employed are preferably dimethyltin dineodecanoate, tin octoate, tin neodecanoate or mixtures of these and blowing catalysts employed are DBU (1.8-diazabicyclo[5.4.0]undec-7-ene), tetramethylguanidine or mixtures thereof.

It is preferable when component D) comprises or consists of at least one gelling catalyst and/or at least one blowing catalyst.

### Component E):

It is further possible to employ surface-active additives, in particular silicone surfactants and more preferably siloxane-polyoxyalkylene copolymers and polydimethylsiloxane-polyoxyalkylene copolymers in the production of the foams. Other surface-active additives, for example emulsifiers, may also be present. Suitable foam stabilizers especially include low-emission foam stabilizers, such as for example products of the Tegostab® BF series (Evonik Operations GmbH).

### Component F):

Optional auxiliary and additive substances distinct from component E) that may likewise be employed as component F) include reaction retarders (for example acidic substances such as hydrochloric acid or organic acyl halides), cell regulators (for example paraffins or fatty alcohols or dimethylpolysiloxanes), pigments, dyes, flame retardants (for example tricresyl phosphate or ammonium polyphosphate), further stabilizers against aging and weathering effects, antioxidants plasticizers, fungistatic and bacteriostatic substances, fillers (for example barium sulfate, kieselguhr, carbon black or whiting) and release agents. These auxiliary and additive substances for optional co-use are described for example in EP-A 0 000 389, pages 18-21. Further examples of auxiliary and additive substances for optional co-use according to the invention and also details of the manner of use and mode of action of these auxiliary and additive substance are described in Kunststoff-Handbuch, volume VII, edited by G. Oertel, Carl-Hanser-Verlag, Munich, 3rd edition, 1993, for example on pages 104 to 127.

### Aliphatic Flexible Polyurethane Foam Based on Renewable (Bio-Based) or Sustainable Raw Materials:

The components to be employed in the process according to the invention may be biobased or non-biobased. However, in the context of making production processes environmentally friendly it is generally desirable to use starting materials based on renewable (biobased) or sustainable raw materials.

In the context of the present invention the term “biobased” is defined such that a component, a compound, a material or the like—for example aliphatic oligomeric polyisocyanates according to component B) or a starting material for producing such an aliphatic oligomeric polyisocyanate—has been obtained or prepared from renewable sources (for example plants, microbes, algae or animals). This is by contrast with compounds and materials obtained or prepared from non-renewable sources. Non-renewable sources include, for example, fossil raw materials formed from dead living organisms in geological prehistory. These include in particular crude oil, lignite, hard coal, peat, and natural gas. Compounds and materials obtained or prepared from non-renewable sources are defined in the context of the present invention as non-biobased or “synthetically produced”. Biobased starting materials can be obtained directly from the abovementioned renewable sources or can be produced by subsequent reactions from compounds or materials obtained from such sources. Thus the aliphatic oligomeric polyisocyanates of component B) may be based on di- and polyisocyanates which have in turn been produced from biobased diamines. One example of such a diamine is 1,5-diaminopentane (1,5-PDA).

It is especially likewise generally desirable to employ CO₂-based starting materials in relatively large amounts. The polyether carbonate polyols described at A3) are starting materials of this kind. Using these compounds makes it possible to markedly improve the CO₂ footprint of the flexible polyurethane foams according to the invention.

Flexible polyurethane foams are also producible when using polyester polyols (A4) as polyol components (WO 2014/064130). Replacing the aromatic isocyanates used in WO 2014/064130 with those based on renewable raw materials such as the 1,3,5-tris(6-isocyanatopentyl)-1,3,5-triazinane-2,4,6-trione (B1) employed here and also biobased low molecular weight alcohols, for example bioethanol, makes it possible to produce flexible polyurethane foams having a proportion of renewable raw materials of >65%, preferably ≥75% and particularly preferably of more than ≥80%. It was surprisingly also found that the use of 1,3,5-tris(6-isocyanatopentyl)-1,3,5-triazinane-2,4,6-trione (B1) and biopolyester polyols (A4) produced from biosuccinic acid and diethylene glycol having an OH number 63.2 and an ester group concentration of up to 10.1 mol/kg made it possible to produce foams which were not producible when using tolylene diisocyanate blends of tolylene diisocyanate comprising a proportion of about 80% by weight of 2,4-tolylene diisocyanate and about 20% by weight of 2,6-tolylene diisocyanate and tolylene diisocyanate comprising a proportion of about 65% by weight of 2,4-tolylene diisocyanate and about 35% by weight of 2,6-tolylene diisocyanate (C2), as described in WO 2014/064130 A1.

### Foam Production:

The polyurethane foams are preferably in the form of flexible polyurethane foams and may be produced as molded foams or else as slabstock foams. The invention therefore provides a process for producing the optionally partly biobased flexible polyurethane foams.

The optionally partly biobased discoloration-resistant flexible polyurethane foams obtainable by the invention can be used for example in the following applications: Textile foams (for example in brassieres, shoulder pads, furniture upholstery, textile inlays), body-supporting elements (for example in upholstery, mattresses, furniture, automobile seats, motorcycle seats, headrests, armrests) sponges and foam films for use in automotive parts (for example in headliners, door cards and seat pads).

The flexible polyurethane foams obtained or obtainable by the process according to the invention especially have a compressive strength (4th cycle) of ≤14.0 kPa, preferably of ≤12.0 kPa, particularly preferably of 2.0 kPa to 8.0 kPa and very particularly preferably of 3.0 to 7.0 kPa measured according to DIN EN ISO 3386-1 and/or a compression set value (CS) of ≤3.5%, preferably of ≤3.0%, more preferably of ≤2.5% and particularly preferably of 0.1% to 2.0% measured according to DIN EN ISO 1856-2008.

### Embodiments

The present invention especially relates to the following embodiments:

In a first embodiment, the invention relates to a process for producing flexible polyurethane foams by reaction of a composition comprising the components
A) at least one monohydroxy-functional compound and at least one polyol and
B) at least one aliphatic oligomeric polyisocyanate at an isocyanate index of at least 80, wherein the composition further contains the components C) to F)
C) at least one chemical and/or physical blowing agent;
D) at least one catalyst;
E) optionally a surface-active compound and
F) optionally auxiliary and additive substances distinct from component E).

In a second embodiment the invention relates to a process according to embodiment 1, characterized in that the monohydroxy-functional compound of component A) is selected from the group comprising or consisting of
A1) primary, secondary and/or tertiary monohydroxy-functional compounds having 1 to 12 carbon atoms, preferably primary monohydroxy-functional compounds, and/or
A2) polymeric monohydroxy-functional compounds, preferably polyether monools, polycarbonate monools, polyester carbonate monools, polyether carbonate monools, polyether ester carbonate monools and/or mixtures thereof, wherein the polymeric monohydroxy-functional compound particularly preferably has a primary hydroxyl group.

In a third embodiment the invention relates to a process according to embodiment 2, characterized in that the monohydroxy-functional compound A1) is selected from the group comprising or consisting of acyclic and/or cyclic monohydroxy-functional alkanols and/or acyclic and/or cyclic monohydroxy-functional alkenols, preferably methanol, ethanol, isopropanol, n-propanol, isobutanol, n-butanol, sec-butanol, tert-butanol, pentan-1-ol, pentan-2-ol, pentan-3-ol, 2-methylbutan-1-ol, 2-methylbutan-2-ol, 3-methylbutan-1-ol, 3-methylbutan-2-ol, 2,2-dimethylpropan-1-ol, hexan-1-ol, hexan-2-ol, hexan-3-ol, 2-methylpentan-1-ol, 3-methylpentan-1-ol, 4-methylpentan-1-ol, 2-methylpentan-2-ol, 3-methylpentan-2-ol, 2,2-dimethylbutan-1-ol, 2,3-dimethylbutan-1-ol, 3,3-dimethylbutan-1-ol, 2,3-dimethylbutan-2-ol, 3,3-dimethylbutan-2-ol, 2-ethyl-1-butanol, 2-methyl-3-butyn-2-ol, 3-butyn-1-ol, propargyl alcohol, 1-tert-butoxy-2-propanol, 1-heptanol, 2-heptanol, 3-heptanol, 4-heptanol, 1-octanol, 2-octanol, 3-octanol, 4-octanol, 1-nonanol, 2-nonanol, 3-nonanol, 4-nonanol, 5-nonanol, 1-decanol, 2-decanol, 3-decanol, 4-decanol, 5-decanol, 1-undecanol, 2-undecanol, 3-undecanol, 4-undecanol, 5-undecanol, 6-undecanol, 1-dodecanol, 2-dodecanol, 3-dodecanol, 4-dodecanol, 5-dodecanol, 6-dodecanol or mixtures thereof.

In a fourth embodiment the invention relates to a process according to embodiment 2 or 3, characterized in that the polymeric monohydroxyfunctional compound A2) has a hydroxyl number of 20 to 250 mg KOH/g, preferably 20 to 112 mg KOH/g and particularly preferably 20 to 50 mg KOH/g measured according to DIN 53240-3:2016-03.

In a fifth embodiment the invention relates to a process according to any of embodiments 2 to 4, characterized in that the amount of substance fraction of OH groups in the sum of components A1) and A2) is 25.0 mol % to 90.0 mol %, preferably 35.0 to 85.0 mol %, particularly preferably 40.0 to 80.0 mol %, based on the total amount of substance of OH groups in component A).

In a sixth embodiment the invention relates to a process according to any of embodiments 2 to 5, characterized in that the equivalent ratio of OH groups in the sum of components A1) and A2) to the NCO groups of components B) is 0.15 to 0.65, preferably 0.20 to 0.55 and particularly preferably 0.25 to 0.50.

In a seventh embodiment the invention relates to a process according to any of the preceding embodiments, characterized in that the polyol of component A) is selected from the group comprising or consisting of
A3) polyether carbonate polyols,
A4) polyether polyols, polyester polyols, polycarbonate polyols
   and/or mixtures thereof, wherein the polyol of component A) preferably comprises or consists of at least one polyether carbonate polyol A3).

In an eighth embodiment the invention relates to a process according to any of the preceding embodiments, characterized in that component A) additionally contains at least one chain extender and/or crosslinker selected from the group comprising or consisting of
A5) NCO-reactive compounds having an OH and/or NH functionality of at least 2 and a molecular weight of 62 to 800 g/mol, wherein the NCO-reactive compound A5) is preferably selected from the group comprising or consisting of ethylene glycol, diethylene glycol, 1,2-propanediol, 1,3-propanediol, 1,4-butanediol, 1,6-hexanediol, glycerol, 1,1,1-trimethylolpropane, pentaerythritol, monoethanolamine, diethanolamine or mixtures thereof.

In a ninth embodiment the invention relates to a process according to any of the preceding embodiments, characterized in that the aliphatic oligomeric polyisocyanate of component B) comprises isocyanate-bearing oligomers formed from (2n+1) aliphatic polyisocyanates, wherein n is a natural number from 1 to 10 and the aliphatic oligomeric polyisocyanate of component B) consists of these isocyanate-bearing oligomers to an extent of at least 90.0% by weight.

In a tenth embodiment the invention relates to a process according to embodiment 9, characterized in that the aliphatic oligomeric polyisocyanate of component B) comprises an isocyanate-bearing trimer, wherein component B) especially contains a mixture of this trimer and at least one further isocyanate-bearing oligomer where n is a natural number from 2 to 10 and the aliphatic oligomeric polyisocyanate of component B) consists of these isocyanate-bearing trimers to an extent of at least 30.0% by weight, preferably 30.0% to 80.0% by weight.

In an eleventh embodiment the invention relates to a process according to any of the preceding embodiments, characterized in that the aliphatic oligomeric polyisocyanate of component B) contains isocyanurate and/or iminooxadiazinedione groups.

In a twelfth embodiment the invention relates to a process according to any of the preceding embodiments, characterized in that the aliphatic oligomeric polyisocyanate of component B) comprises an isocyanate-bearing trimer of formula (VI) and/or formula (VII), in each case formed from 3 aliphatic polyisocyanates, wherein R is independently at each occurrence an aliphatic C1 to C15 carbon chain.

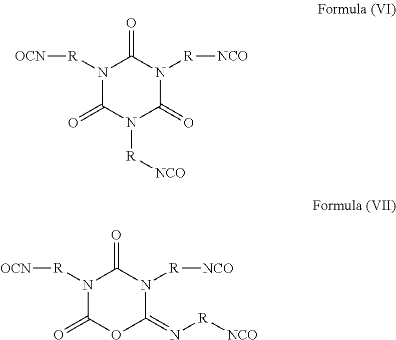

In a thirteenth embodiment the invention relates to a process according to any of the preceding embodiments, characterized in that the aliphatic oligomeric polyisocyanate of component B) is produced from a diisocyanate having 1 to 15 carbon atoms, wherein the diisocyanate is preferably selected from 1,5-pentamethylene diisocyanate and/or 1,6-hexamethylene diisocyanate.

In a fourteenth embodiment the invention relates to a process according to any of the preceding embodiments, characterized in that component B) has an average NCO functionality per molecule of ≥2.0, preferably of 2.3 to 4.3, particularly preferably of 2.5 to 4.2, very particularly preferably of 2.8 to 4.1 and most preferably of 3.0 to 4.0.

In a fifteenth embodiment the invention relates to a process according to any of the preceding embodiments, characterized in that component B) has a content of free NCO groups of 5.0% to 30.0% by weight, preferably of 10.0% to 27.0% by weight and particularly preferably of 15.0% to 24.0% by weight based on the total weight of component B) determined according to DIN EN ISO 11909:2007.

In a sixteenth embodiment the invention relates to a process according to any of the preceding embodiments, characterized in that the composition has a content of monomeric diisocyanates of <1.0% by weight, particularly preferably of <0.5% by weight, very particularly preferably of <0.3% by weight and most preferably of <0.1% by weight based on the total weight of the composition determined by gas chromatography according to DIN EN ISO 10283:2007-11.

In a seventeenth embodiment the invention relates to a process according to any of the preceding embodiments, characterized in that component D) comprises or consists of at least one gelling catalyst and/or at least one blowing catalyst.

In an eighteenth embodiment the invention relates to a process according to any of the preceding embodiments, characterized in that the reaction is carried out at an isocyanate index of 85 to 115, preferably of 90 to 110.

In a nineteenth embodiment the invention relates to a flexible polyurethane foam obtained or obtainable by a process according to any of embodiments 1 to 18.

In a twentieth embodiment the invention relates to a flexible polyurethane foam according to the embodiment 19, characterized in that the flexible polyurethane foam has a compressive strength (4th cycle) of ≤14.0 kPa, preferably of ≤12.0 kPa, particularly preferably of 2.0 kPa to 8.0 kPa and very particularly preferably from 3.0 to 7.0 kPa measured according to DIN EN ISO 3386-1.

In a twenty-first embodiment the invention relates to a flexible polyurethane foam according to embodiment 19 or 20, characterized in that the flexible polyurethane foam has a compression set value (CS) of ≤3.5%, preferably of ≤3.0%, more preferably of ≤2.5% and particularly preferably of 0.1% to 2.0% measured according to DIN EN ISO 1856-2008.

In a twenty-second embodiment the invention relates to the use of a flexible polyurethane foam according to any of embodiments 19 to 21 as or for production of body-supporting elements, in particular upholstery, mattresses, furniture, automobile seats and motorcycle seats.

In a twenty-third embodiment the invention relates to the use of a monohydroxy-functional compound in conjunction with an aliphatic oligomeric polyisocyanate at an isocyanate index of at least 80, in particular of 85 to 115, preferably of 90 to 110, for reducing the compressive strength and/or the compression set value of flexible polyurethane foams.

### Examples and Comparative Examples

The present invention will now be elucidated with reference to examples, but is not limited thereto.

### Employed Components:

### Employed Components A1):

ethanol
butanol

### Employed Component A2):

Desmophen® LB 25 (polyether monool, OH number: 25 mg KOH/g (according to DIN 53240-3:2016-03), viscosity: 4600 mPa·s)

### Employed Component A3):

Cardyon® LC 05 (polyether carbonate polyol, OH number: 55 mg KOH/g, typical CO₂ incorporation: 14% by weight)

### Employed Components A5):

diethylene glycol (DEG)
diethanolamine (DEA)

### Employed Component B1):

Desmodur® eco N 7300 (biobased, isocyanurate-containing aliphatic polyisocyanate based on 1,5-pentamethylene diisocyanate (PDI) having an NCO content of 21.9% by weight (according to DIN EN ISO 11909:2007), an average NCO functionality of ≥3.0 (according to GPC), a content of monomeric PDI of at most 0.3% by weight and a viscosity of 9500 mPa·s (at 23° C., determined according to DIN EN ISO 3219))

### Employed Component B2):

Desmodur® ultra N 3600 (isocyanurate-containing aliphatic polyisocyanate based on 1,6-diisocyanatohexane (HDI) having an NCO content of 23.0% by weight (according to DIN EN ISO 11909:2007), an average NCO functionality of 3.2 (according to GPC), a content of monomeric HDI of at most 0.1% by weight and a viscosity of 1200 mPa·s (23° C., determined according to DIN EN ISO 3219))

### Employed Component C):

water

### Employed Components D):

Kosmos® Pro 1 (tin (II) neodecanoate)
Fomrez® UL-28 (dimethyltin neodecanoate)
DBU (1,8-diazabicyclo[5.4.0]undec-7-ene)

### Employed Components E):

Tegostab® BF2370 (Evonik Operations GmbH, Essen)
Tegostab® B8783 LF 2 (Evonik Operations GmbH, Essen)

### Employed Components F):

Ortegol® 500 (Evonik Operations GmbH, Essen)

### Measurement Methods Used:

Determination of compressive strength (CV) was carried out according to DIN EN ISO 3386-1. To carry out the measurements two or three test specimens having dimensions of 6 cm×6 cm×3 cm were cut. The tests were carried out on a Zwick/Roell 2.5 kN RetroLine instrument at 22° C. and 47% relative humidity. The measurement geometry consists of a base plate, onto which the sample body is placed, and a pressure plate. On commencement of the measurement the distance between the two plates is equal to the height of the sample. The measurements consist of three preliminary cycles and one subsequent measurement cycle, wherein data are captured for the first preliminary cycle and the measurement cycle. A cycle consists of a deformation at a speed of 100 mm/min in the range from 0% to 70% and removal of load until the measurement plates have returned to their original separation. The measured values are used to determine the compressive stress/compressive strength at various deformations. An often reported value is compressive strength at 40% deformation (CV40) which may be calculated according to the formula below.

$${CV}_{40} [ k P a ] = \frac{{F}_{40}}{{A}_{compress}} \cdot 1000$$

where:
   C₄₀=compressive strength/compressive stress value at a deformation of 40% [kPa]
   F₄₀=force at 40% deformation, determined in 4th load cycle [N]
   A_{compress}=area of sample body [mm²]
Compression set (CS) is determined according to DIN EN ISO 1856-2008. To this end three test specimens measuring 5 cm×5 cm×2.5 cm are cut. These are clamped between two plates such that they are compressed by 50% and stored in this state for 22 hours in an oven at 70° C. The foams are then removed from the compression holder and after 30 minutes of storage at 22° C. the height of the test specimens is determined. 3 test specimens are examined and the average CS is reported as the result;
Viscosity: The viscosity of the Desmodur products (Desmodur ultra N 3600, Desmodur ultra N3300, Desmodur eco N7300) is measured according to DIN EN ISO 3219 using RheolabQC instruments from Anton Paar;
Cream time: This is the period from commencement of the mixing operation until a visually perceptible change in the reaction mixture, i.e. until first rising of the reaction mixture. In order to see the rising better, guidelines (lines running obliquely upward) may be drawn with a pen on the vessel containing the reaction mixture.
Fiber time (tack-free time): In the context of the present invention fiber time is understood as meaning the so-called “tack-free-time”. The tack-free time is to be understood as meaning the period from commencement of mixing until the state/point in time at which the surface of the foam composition is no longer tacky. It is determined by dabbing the foam which is no longer rising with a wooden spatula. The point in time from which tackiness is no longer observed is described as the tack-free time.
Apparent density according to DIN EN ISO 845.
Tensile test according to DIN EN ISO 1798:2008 (breaking stress and elongation at break are determined here)

### EXAMPLES

### Example 1

An isocyanate-reactive composition of 120.33 g of Cardyon® LC05, 8.65 g of ethanol, 3.01 g of diethylene glycol, 1.81 g of diethanolamine, 1.81 g of water, 2.25 g of Tegostab® BF 2370 and 0.50 g of DBU was mixed with a stirrer at 1150 rpm for 30 s. Then 1.25 g of Kosmos® Pro 1 and 2.37 g of Fomrez® UL-28 were added to the mixture and this was in turn mixed with a stirrer (1150 rpm for 15 s). This mixture was mixed with 108.03 g of Desmodur® ultra N 3600 with a stirrer at 2100 rpm for 15 s and poured into a mold. The raw material temperature was 23° C. Curing was effected at ambient temperature. The foam had set after 130 s.

### Further Examples and Comparative Examples

The further examples and comparative examples reported in the table which follows were produced analogously to example 1 with the amounts (in [g]) specified in this table. In the examples where component A2 was additionally used, the addition was made together with the components mixed with a stirrer at 1150 rpm for 30 s. Component B2 was used analogously to component Blin the corresponding examples and comparative examples. The same applies to components E) and F).

| | OH | | | | | | | Comparative | Comparative |
|---|---|---|---|---|---|---|---|---|---|
| Component | number | Example 1 | Example 2 | Example 3 | Example 4 | Example 5 | Example 6 | example 1 | example 2 |
| A1 (ethanol) | 1218 | 8.65 | 14.55 | — | 8.27 | 13.87 | 8.11 | — | — |
| A1 (butanol) | 756 | — | — | 14.43 | — | — | — | — | — |
| A2 | 25 | — | 14.35 | — | — | — | 21.08 | — | — |
| A3 | 55 | 120.33 | 68.12 | 103.61 | 115.07 | 97.60 | 95.42 | 140.13 | 146.16 |
| A5 (diethylene glycol) | 1057 | 3.01 | 1.70 | 2.59 | 2.88 | 2.44 | 2.39 | 3.50 | 3.65 |
| A5 (diethanolamine) | 1609 | 1.81 | 1.02 | 1.55 | 1.73 | 1.46 | 1.43 | 2.10 | 2.19 |
| C | 6228 | 1.81 | 2.18 | 2.07 | 1.73 | 1.46 | 1.86 | 2.10 | 2.19 |
| D (Kosmos ® Pro 1) | | 1.25 | 1.25 | 0.75 | 1.25 | 1.25 | 1.25 | 1.25 | 1.25 |
| D (Fomrez ® UL-28) | | 2.37 | 2.37 | 2.37 | 2.37 | 2.37 | 2.37 | 2.25 | 2.25 |
| D (DBU) | | 0.50 | 0.50 | 0.50 | 0.50 | 0.50 | 0.50 | 0.62 | 0.62 |
| E (Tegostab BF2370) | | 2.25 | 2.25 | — | 1.00 | 2.25 | 2.25 | 1.00 | 1.00 |
| E (Tegostab ® B8783 LF2) | | — | — | 0.41 | — | — | — | — | — |
| F | | — | — | 0.10 | — | — | — | — | — |
| B1 | | — | 141.70 | 121.61 | 115.21 | 126.79 | 113.34 | 97.04 | — |
| B2 | | 108.03 | — | — | — | — | — | — | 90.68 |
| Total | | 250 | 250 | 250 | 250 | 250 | 250 | 250 | 250 |
| Index | | 100 | 104.5 | 101.8 | 99.9 | 100.1 | 101.2 | 99.5 | 99.5 |
| Equivalent ratio* | | 0.31 | 0.44 | 0.31 | 0.30 | 0.46 | 0.32 | — | — |
| Cream time [s] | | 63 | 51 | 49 | 58 | 52 | 65 | 65 | 60 |
| Fiber time (tack-free time) [s] | | 130 | 180 | 120 | 150 | 100 | 198 | 180 | 180 |
| Density [kg/m³] | | 100 | 84 | 85 | 111 | 114 | 106 | 109 | 104 |
| Breaking stress [kPa] | | 67 | 84 | 86 | 97 | 100 | 72 | 79 | 79 |
| Elongation at break [%] | | 147 | 147 | 138 | 79 | 176 | 103 | 62 | 67 |
| CS [%] | | 1.8 | 0.6 | 1.6 | 1.2 | 0.5 | 1.2 | 3.9 | 2.3 |
| Compressive strength | | 5.3 | 3.9 | 6.1 | 11.9 | 7.6 | 6.1 | 14.1 | 14.5 |
| (CV₄₀, 40% compression) | | | | | | | | | |
| 4th cycle [kPa] | | | | | | | | | |

*Equivalent ratio of OH groups of the sum of components Al) and A2) to the NCO groups of components B).

It is first of all clearly apparent that the use of monohydroxy-functional compounds (in the production of aliphatic flexible foams based on polyisocyanates)—such as for example ethanol—generally results in a marked reduction in both compressive strength and compression set value compared to the comparative examples without such compounds. Accordingly the inventive compositions afford more flexible foams having improved resilience. Moreover, it is nevertheless possible to obtain foams having similar densities to the comparative examples (see, for example, examples 1, 4, 5 and 6 compared to comparative examples 1 and 2). As a result, the obtained aliphatic flexible polyurethane foams are very suitable for producing high-quality body-supporting elements such as for example mattresses.

Furthermore, the comparison of example 4 and example 5 shows that a higher content of monohydroxy-functional compounds at virtually identical density of the foams results in an improved compression set value and a lower compressive strength.

The comparison of example 4 and example 6 shows that the use of a monohydroxyl-functional compound (A1) (here ethanol) in conjunction with a polymeric monohydroxyl-functional compound A2) (here polyether monool) is advantageous for reducing compressive strength at similar density of the foams. Furthermore, example 2 shows that combining monohydroxy-functional compounds A1) with polymeric monohydroxy-functional compounds A2) makes it possible to obtain flexible polyurethane foams having a very low compressive strength and low compression set values with good densities.

Finally, examples 2 to 6 in comparison with example 1 and the comparative examples demonstrate that the process according to the invention also affords flexible polyurethane foams having a low compressive strength and low compression set values when using biobased and sustainable reactants (for example Desmodur® eco N 7300 and Cardyon® LC 05). The process according to the invention is therefore also suitable for producing flexible polyurethane foam with an improved environmental footprint (sustainability etc.) coupled with a very good properties.

1. A process for producing flexible polyurethane foams by reaction of a composition comprising the components
A) at least one monohydroxy-functional compound and at least one polyol and
B) at least one aliphatic oligomeric polyisocyanate
at an isocyanate index of at least 80, wherein the composition further contains the components C) to F)
C) at least one chemical and/or physical blowing agent;
D) at least one catalyst;
E) optionally a surface-active compound and
F) optionally auxiliary and additive substances distinct from component E).

2. The process as claimed in claim 1, wherein the monohydroxy-functional compound of component A) is selected from the group comprising or consisting of
A1) primary, secondary and/or tertiary monohydroxy-functional compounds having 1 to 12 carbon atoms and/or
A2) polymeric monohydroxy-functional compounds wherein the polymeric monohydroxy-functional compound has a primary hydroxyl group.

3. The process as claimed in claim 2, wherein in the monohydroxy-functional compound A1) is selected from the group comprising or consisting of acyclic and/or cyclic monohydroxy-functional alkanols and/or acyclic and/or cyclic monohydroxy-functional alkenols.

4. The process as claimed in claim 2, wherein the polymeric monohydroxy-functional compound A2) has a hydroxyl number of 20 to 250 mg KOH/g measured according to DIN 53240-3:2016-03 and/or in that the amount of substance fraction of the OH groups of the sum of components A1) and A2) is 25.0 to 90.0 mol % based on the total amount of substance of the OH groups of component A).

5. The process as claimed in claim 2, wherein the equivalent ratio of OH groups in the sum of components A1) and A2) to the NCO groups of components B) is 0.15 to 0.65.

6. The process as claimed in claim 1, wherein the polyol of component A) is selected from the group comprising or consisting of
A3) polyether carbonate polyols,
A4) polyether polyols, polyester polyols, polycarbonate polyols
and/or mixtures thereof.

7. The process as claimed in claim 1, wherein the aliphatic oligomeric polyisocyanate of component B) comprises isocyanate-bearing oligomers formed from (2n+1) aliphatic polyisocyanates, wherein n is a natural number from 1 to 10 and the aliphatic oligomeric polyisocyanate of component B) consists of these isocyanate-bearing oligomers to an extent of at least 90.0% by weight.

8. The process as claimed in claim 1, wherein the aliphatic oligomeric polyisocyanate of component B) contains isocyanurate and/or iminooxadiazindione groups.

9. The process as claimed in claim 1, wherein the aliphatic oligomeric polyisocyanate of component B) comprises an isocyanate-bearing trimer of formula (VI) and/or formula (VII), in each case formed from 3 aliphatic polyisocyanates, wherein R is independently at each occurrence an aliphatic C1 to C15 carbon chain.

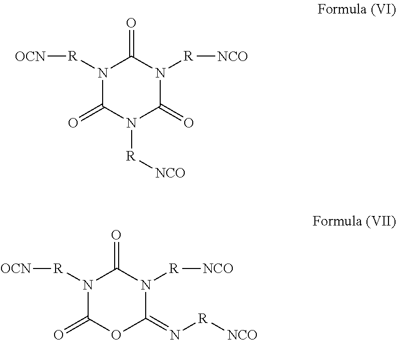

10. The process as claimed in claim 1, wherein the aliphatic oligomeric polyisocyanate of component B) is produced from a diisocyanate having 1 to 15 carbon atoms.

11. The process as claimed in claim 1, wherein component B) has an average NCO functionality per molecule of ≥2.0 and/or in that the composition has a content of monomeric diisocyanates of <1.0% by weight based on the total weight of the composition determined by gas chromatography according to DIN EN ISO 10283:2007-11.

12. A flexible polyurethane foam obtained or obtainable by a process according to any of claim 1.

13. The flexible polyurethane foam as claimed in claim 12, wherein the flexible polyurethane foam has a compressive strength (4th cycle) of ≤14.0 kPa a measured according to DIN EN ISO 3386-1 and/or in that the flexible polyurethane foam has a compression set value (CS) of ≤3.5% measured according to DIN EN ISO 1856-2008.

14. A method for production of body-supporting elements comprising providing the flexible polyurethane foam as claimed in claim 12.

15. A method for reducing the compressive strength and/or the compression set value of flexible polyurethane foams by providing a monohydroxy-functional compound in conjunction with an aliphatic oligomeric polyisocyanate at an isocyanate index of at least 80.
